(19) United States
(12) Patent Application Publication
(10) Pub. No.: US 2026/0332080 A1
(43) Pub. Date: Oct. 22, 2026

(54) MOTOR CONTROL DEVICE

(71) Applicant: Hitachi Astemo, Ltd., Hitachinaka-shi, Ibaraki (JP)

(72) Inventors: Kentaro MATSUO, Hitachinaka-shi, Ibaraki (JP); Shun TANIGUCHI, Tokyo (JP); Toshiyuki AJIMA, Tokyo (JP)

(73) Assignee: Hitachi Astemo, Ltd., Hitachinaka-shi, Ibaraki (JP)

(21) Appl. No.: 19/113,230

(22) PCT Filed: Oct. 31, 2022
(86) PCT No.: PCT/JP2022/040762

§ 371 Date: Mar. 19, 2025

(51) Int. Cl. H02P 27/08; H02M 1/00; H02M 1/38; H02M 7/539; H02P 6/08

(52) U.S. Cl. CPC H02P 27/085; H02M 1/0009; H02M 1/385; H02M 7/539; H02P 6/08

(57) ABSTRACT

The motor control device includes: a current detection unit that acquires a current detection value corresponding to a current flowing through an AC motor; a current control unit that acquires a current instruction value to the AC motor and that calculates a voltage instruction value to the AC motor in each given calculation period, based on the current instruction value and on the current detection value; and a voltage control unit that executes a control calculation based on the voltage instruction value in each calculation period to obtain a duty instruction for generating a gate signal. The current detection unit acquires the current detection value at least twice in each calculation period, and the voltage control unit obtains at least two kinds of the duty instructions in each calculation period and reflects the duty instructions in the gate signal.

### TECHNICAL FIELD

The present invention relates to a device that controls a motor.

### BACKGROUND ART

Conventionally, a motor used for driving an automobile or the like is required to have such features as smallness in size, high power output, and high efficiency. In recent years, to offer these features, a high-speed rotation motor with a rotating speed higher than that of a conventional motor has been adopted.

When the rotating speed of a three-phase AC synchronous motor driven by an inverter is increased, the electric angle frequency of the motor increases to become higher than the electric angle frequency at the time of normal operation of the motor. As a result, a time per one electric angle period gets shorter. In a motor control device that detects a current flowing through the motor and controls driving of switching elements of the inverter, based on a current detection value, i.e., the detected current value, to control the motor, therefore, the number of times of reflecting the current detection value in motor control during one electric angle period decreases. Such a decrease in the number of times of reflecting the current detection value in motor control at the time of high-speed rotation of the motor leads to a drop in motor control performance, which may cause an error of torque generated by the motor, pulsation, overcurrent, and the like.

To increase the number of times of reflecting the current detection value in motor control at the time of high-speed rotation of the motor, a motor control calculation carried out by the motor control device is made faster to shorten the calculation period of the motor control calculation. However, a time required for the motor control calculation depends on the processing capability of a microcomputer that executes the calculation, and improving the processing capability of the microcomputer leads to an increase in manufacturing cost and power consumption. This puts a limit on making the motor control calculation faster.

Concerning motor control at the time of high-speed rotation of the motor, for example, a technique described in PTL 1 is known. PTL 1 describes a control device of a motor drive apparatus. According to this control device, when a synchronous control mode is selected, the control device executes a current detection process IS in each reference calculation period T0 set to ½ of a carrier period, the current detection process IS being executed to detect a current flowing through a coil of an AC motor, and executes also a voltage control process VC in a period N times (N is an integer of 2 or more) the reference calculation period T0 such that the voltage control process VC is executed once as N current detection values obtained by N current detection processes IS are fed back. This control device properly reflects a current detection value obtained in a short period while keeping an overall calculation load within a processing capability range of a calculation process unit, thus suppressing the occurrence of aliasing of current sampling.

### CITATION LIST

### Patent Literature

PTL 1: JP 2011-83068 A

### SUMMARY OF INVENTION

### Technical Problem

According to the technique of PTL 1, the current detection process can be made faster but the period of the voltage control process remains equal to the carrier period. Therefore, the number of times of reflecting the current detection value in motor control during one electric angle period remains the same, which means that the number of times of reflecting the current detection value in motor control at the time of high-speed rotation of the motor cannot be increased.

The present invention has been conceived to solve the above problem, and a main object of the present invention is to improve motor control performance while suppressing an increase in a processing load in execution of motor control at the time of high-speed rotation.

### Solution to Problem

A motor control device according to the present invention generates a gate signal for controlling operation of a switching element of an inverter having a plurality of the switching elements, and outputs the generated gate signal to the inverter, thereby controlling driving of an AC motor connected to the inverter. The motor control device includes: a current detection unit that acquires a current detection value corresponding to a current flowing through the AC motor; a current control unit that acquires a current instruction value to the AC motor and that calculates a voltage instruction value to the AC motor in each calculation period that is a given calculation period, based on the current instruction value and on the current detection value; and a voltage control unit that executes a control calculation based on the voltage instruction value in the each calculation period to obtain a duty instruction for generating the gate signal. The current detection unit acquires the current detection value at least twice in the each calculation period, and the voltage control unit obtains at least two kinds of the duty instructions in the each calculation period and reflects the duty instructions in the gate signal.

### Advantageous Effects of Invention

According to the present invention, in motor control at the time of high-speed rotation of the motor, motor control performance can be improved as an increase in a processing load is suppressed.

### BRIEF DESCRIPTION OF DRAWINGS

FIG. 1 is an overall configuration diagram of a motor drive system including a motor control device according to one embodiment of the present invention.

FIG. 2 is a block diagram showing a functional configuration of the motor control device according to the one embodiment of the present invention.

FIG. 3 is a block diagram of a current conversion unit according to the one embodiment of the present invention.

FIG. 4 is a block diagram of a voltage control unit according to the one embodiment of the present invention.

FIGS. 5A to 5B are a comparison chart in which dead time compensation according to a conventional example and dead time compensation according to the present invention are compared with each other.

FIGS. 6A to 6B are a comparison chart in which a calculation process according to the conventional example and a calculation process according to the present invention are compared with each other.

### DESCRIPTION OF EMBODIMENTS

Embodiments of the present invention will hereinafter be described in detail with reference to the drawings. In the embodiments, an example of application to a motor drive system incorporated and used in electric vehicles, such as an electric car and a hybrid car, will be described.

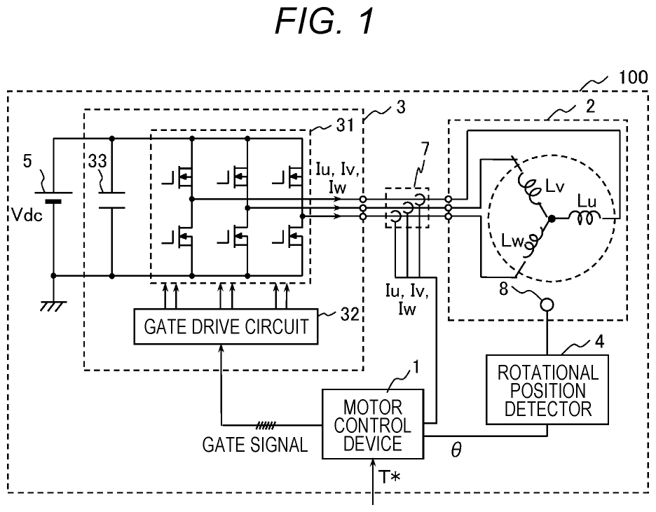

FIG. 1 is an overall configuration diagram of a motor drive system including a motor control device according to one embodiment of the present invention. In FIG. 1, a motor drive system 100 includes a motor control device 1, an AC motor (which will hereinafter be simply referred to as a “motor”) 2, an inverter 3, a rotational position detector 4, and a high-voltage battery 5.

The motor control device 1 controls the operation of the inverter 3, based on a torque instruction T* corresponding to a target torque request a vehicle makes to the motor 2, thereby generating a gate signal for controlling driving of the motor 2. The motor control device 1 then outputs the generated gate signal to the inverter 3. Details of the motor control device 1 will be described later.

The inverter 3 includes an inverter circuit 31, a gate drive circuit 32, and a smoothing capacitor 33. The gate drive circuit 32 generates a gate drive signal for controlling each of switching elements the inverter circuit 31 has, based on the incoming gate signal from the motor control device 1, and outputs the gate drive signal to the inverter circuit 31. The inverter circuit 31 has pairs of switching elements corresponding respectively to pairs of upper arms and lower arms of a U phase, a V phase, and a W phase. These switching elements are each controlled in accordance with the incoming gate drive signal from the gate drive circuit 32. As a result, DC power supplied from the high-voltage battery 5 is converted into AC power, which is outputted to the motor 2. The smoothing capacitor 33 smooths DC power supplied from the high-voltage battery 5 to the inverter circuit 31.

The motor 2 is a synchronous motor caused to rotate by AC power supplied from the inverter 3, and includes a stator and a rotor. When incoming AC power from the inverter 3 is applied to armature coils Lu, Lv, and Lw disposed on the stator, three-phase alternating currents Iu, Iv, and Iw flow in the motor 2 and the armature coils each generate armature magnetic flux. As a result, armature magnetic flux from the armature coils and magnet magnetic flux from permanent magnets disposed on the rotor act on each other to generate an attractive force and a repulsive force, which creates a torque on the rotor, thus causing the rotor to rotate.

The motor 2 is fitted with a rotational position sensor 8 that detects a rotational position e of the rotor. The rotational position detector 4 calculates the rotational position e from an input signal from the rotational position sensor 8. A result of calculation of the rotational position θ by the rotational position detector 4 is inputted to the motor control device 1 and is used for AC power phase control the motor control device 1 carried out in accordance with a phase of an induced voltage of the motor 2.

It is preferable that the rotational position sensor 8 be a resolver composed of an iron core and a winding. However, providing a sensor using a magnetoresistive element, such as a GMR sensor, or a sensor using a Hall element, as the rotational position sensor 8 poses no problem. The rotational position detector 4 may estimate the rotational position θ by using not an input signal from the rotational position sensor 8 but the three-phase alternating currents Iu, Iv, and Iw flowing through the motor 2 and three-phase AC voltages Vu, Vv, and Vw applied from the inverter 3 to the motor 2.

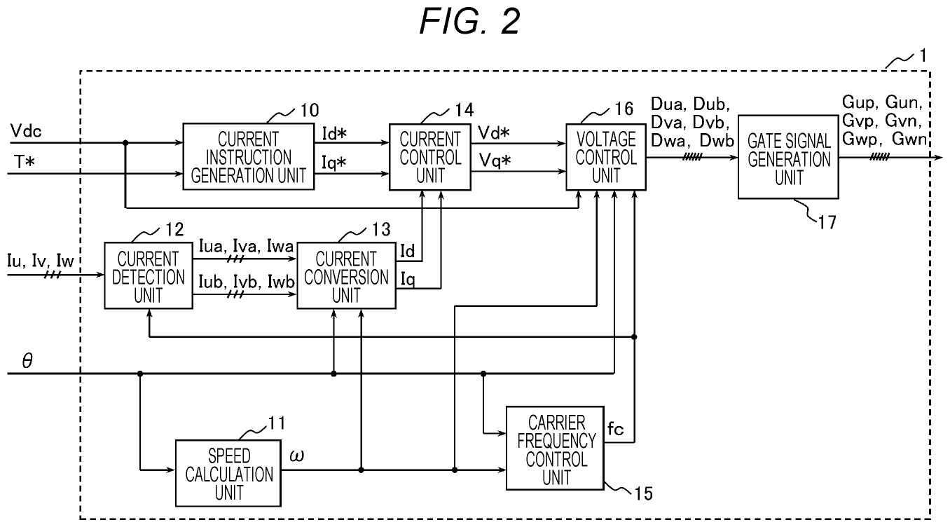

A current sensor 7 is disposed between the inverter 3 and the motor 2. The current sensor 7 detects the three-phase alternating currents Iu, Iv, and Iw (U-phase alternating current Iu, V-phase alternating current Iv, and W-phase alternating current Iw) flowing through the motor 2. The current sensor 7 is composed of, for example, a Hall current sensor or the like. A result of detection of the three-phase alternating currents Iu, Iv, and Iw by the current sensor 7 is inputted to the motor control device 1, and is used for AC power phase control the motor control device 1 carries out, in the same manner as the result of calculation of the rotational position θ by the rotational position detector 4 is used. FIG. 2 shows an example in which the current sensor 7 is composed of three current detectors. However, the current sensor 7 may include two current sensors to detect alternating currents of two phases, and an alternating current of the remaining one phase may be calculated based on a fact that sum of the three-phase alternating currents Iu, Iv, and Iw is zero. Also, a pulsed direct current flowing from the high-voltage battery 5 into the inverter 3 may be detected by a shunt resistance or the like interposed between the smoothing capacitor 33 and the inverter 3, and the three-phase alternating currents Iu, Iv, and Iw may be determined based on the pulsed direct current and on the three-phase AC voltages Vu, Vv, and Vw applied from the inverter 3 to the motor 2.

Details of the motor control device 1 will then be described. FIG. 2 is a block diagram showing a functional configuration of the motor control device 1 according to the one embodiment of the present invention. In FIG. 2, the motor control device 1 includes a current instruction generation unit 10, a speed calculation unit 11, a current detection unit 12, a current conversion unit 13, a current control unit 14, a carrier frequency control unit 15, a voltage control unit 16, and a gate signal generation unit 17, which are functional blocks. The motor control device 1 is composed of, for example, a microcomputer, and this microcomputer executes a given program to provide these functional blocks. Alternatively, some or all of these functional blocks may be provided in the form of a hardware circuit, such as a logic IC or an FPGA.

The current instruction generation unit 10 calculates a d-axis current instruction Id* and a q-axis current instruction Iq*, based on the torque instruction T* and the voltage Vdc of the high-voltage battery 5 that are inputted to the current instruction generation unit 10. In this case, for example, the d-axis current instruction Id* and the q-axis current instruction Iq* corresponding to the torque instruction T* are obtained, using a current instruction map, a formula, or the like that are set in advance.

The speed calculation unit 11 calculates a motor rotating speed ω representing the rotating speed (number of revolutions) of the motor 2, from a time-dependent change in the rotational position θ. The motor rotating speed ω may be expressed as either an angular velocity (rad/s) or the number of revolutions (rpm). These angular velocity and the number of revolutions may be used as mutually exchangeable values.

The current detection unit 12 samples incoming detection signals of the three-phase alternating currents Iu, Iv, and Iw from the current sensor 7 in each given sampling period, and acquires first three-phase alternating current detection values Iua, Iva, and Iwa (a first U-phase alternating current detection value Iua, a first V-phase alternating current detection value Iva, and a first W-phase alternating current detection value Iwa) and second three-phase alternating current detection values Iub, Ivb, and Iwb (a second U-phase alternating current detection value Iub, a second V-phase alternating current detection value Ivb, and a second W-phase alternating current detection value Iwb) at different timings, respectively. The current detection unit 12 samples the three-phase alternating currents Iu, Iv, and Iw in a sampling period half a calculation period of a current control calculation carried out by the current control unit 14, and stores sampling results in the register of the microcomputer, as the first three-phase alternating current detection values Iua, Iva, and Iwa and the second three-phase alternating current detection values Iub, Ivb, and Iwb, respectively. The first three-phase alternating current detection values Iua, Iva, and Iwa represent currents that have been detected at a point of time preceding the start of a current control calculation task by the half of the current control calculation period. The second three-phase alternating current detection values Iub, Ivb, and Iwb represent currents that have been detected at the start of the current control calculation task. To prevent a detection error due to a delay in a current sensor or a circuit, current detection timing is delayed by about several microseconds from the start of the current control calculation task and from the point of time preceding the start of the current control calculation task by the half of the current control calculation period. In other words, the current detection unit 12 acquires current detection values twice in each calculation period of the current control calculation, and outputs the current detection values acquired to the current conversion unit 13 in each calculation period, with current detection values acquired at the first time being outputted as the first three-phase alternating current detection values Iua, Iva, and Iwb and current detection values acquired at the second time being outputted as the second three-phase alternating current detection values Iub, Ivb, and Iwb.

The current conversion unit 13 carries out dq conversion of the first three-phase alternating current detection values Iua, Iva, and Iwa and second three-phase alternating current detection values Iub, Ivb, and Iwb that are acquired by the current detection unit 12, based on the rotational position θ and the rotating speed ω, and calculates a d-axis current value Id and a q-axis current value Iq, based on results of dq conversion of the first and second three-phase alternating current detection values, respectively. In this process, the current conversion unit 13 calculates a d-axis current average value and a q-axis current average value, based on a first d-axis current value Id1 and a first q-axis current value Iq1 that are obtained by dq conversion of the first three-phase alternating current detection values Iua, Iva, and Iwa and on a second d-axis current value Id2 and a second q-axis current value Iq2 that are obtained by dq conversion of the second three-phase alternating current detection values Iub, Ivb, and Iwb. The d-axis current average value and the q-axis current average value that are calculated in this manner are then outputted as the d-axis current value Id and the q-axis current value Iq. Details of a method of calculating the d-axis current value Id and the q-axis current value Iq by the current conversion unit 13 will be described later.

Based on deviation of the d-axis current value Id and the q-axis current value Iq, which are outputted by the current conversion unit 13, from the d-axis current instruction Id* and the q-axis current instruction Iq*, which are outputted by the current instruction generation unit 10, the current control unit 14 calculates a d-axis voltage instruction Vd* and a q-axis voltage instruction Vq* that correspond to the torque instruction T* so that the d-axis current value Id and q-axis current value Iq match the d-axis current instruction Id* and the q-axis current instruction Iq*, respectively. In this case, a calculation delay in a period between the point of detection of the rotational position θ and the three-phase alternating currents Iu, Iv, and Iw and the point of motor control device 1 outputting the gate signal to the inverter 3 is taken into consideration. For example, the d-axis voltage instruction Vd* that remedies deviation of the d-axis current value Id from the d-axis current instruction Id* and the q-axis voltage instruction Vq* that remedies deviation of the q-axis current value Iq from the q-axis current instruction Iq* are calculated in each given calculation period by a current control calculation using such a control method as PI control.

The carrier frequency control unit 15 calculates a carrier frequency fc that is the frequency of a carrier wave used to generate a PWM pulse signal, based on the rotational position θ determined by the rotational position detector 4 and on the rotating speed ω determined by the speed calculation unit 11. For example, the carrier frequency fc is calculated as a carrier frequency at which the number of carrier waves per rotation of the motor 2 matches a given number Nc.

Using the rotational position θ, the motor rotating speed ω, the voltage Vdc of the high-voltage battery 5, and the carrier frequency fc, the voltage control unit 16 obtains duty instruction values Dua, Dub, Dva, Dvb, Dwa, and Dwb of which (Dua, Dva, Dwa) and (Dub, Dvb, Dwb) correspond respectively to the first half and the second half of the carrier wave in three phases, from the d-axis voltage instruction Vd* and the q-axis voltage instruction Vq* that are calculated by the current control unit 14. In this process, the voltage control unit 16 carries out three-phase conversion of the d-axis voltage instruction Vd* and the q-axis voltage instruction Vq* to obtain three-phase voltage instructions Vu*, Vv*, and Vw* (a U-phase voltage instruction value Vu*, a V-phase voltage instruction value Vv*, and a W-phase voltage instruction value Vw*). The voltage control unit 16 then carries out a PWM calculation based on the obtained three-phase voltage instructions Vu*, Vv*, and Vw* and on a triangular carrier wave changing periodically at the carrier frequency fc, determines the pulse width of a gate drive signal to be outputted to each switching element, thereby obtaining the duty instruction values Dua, Dub, Dva, Dvb, Dwa, and Dwb. Details of a method of calculating the duty instruction values Dua, Dub, Dva, Dvb, Dwa, and Dwb by the voltage control unit 16 will be described later.

Based on the duty instruction values Dua, Dub, Dva, Dvb, Dwa, and Dwb obtained by the voltage control unit 16, the gate signal generation unit 17 generates gate signals (PWM pulse signals) Gup, Gun, Gvp, Gvn, Gwp, and Gwn for controlling the operation of the inverter 3. For example, the duty instruction values Dua, Dub, Dva, Dvb, Dwa, and Dwb are converted into given voltage signals, respectively, to generate the gate signals Gup, Gun, Gvp, Gvn, Gwp, and Gwn. The gate signals generated by the gate signal generation unit 17 are outputted from the motor control device 1 to the gate drive circuit 32 of the inverter 3, and are converted into gate drive signals by the gate drive circuit 32. As a result, respective switching elements of the inverter circuit 31 are switched on/off in a controlled manner to adjust an output voltage from the inverter 3.

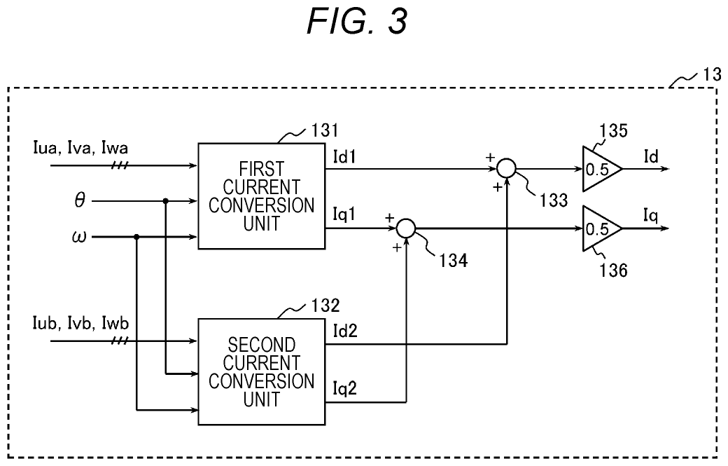

Details of the current conversion unit 13 in the motor control device 1 will then be described. FIG. 3 is a block diagram of the current conversion unit 13 according to the one embodiment of the present invention. The current conversion unit 13 includes a first current conversion unit 131, a second current conversion unit 132, adders 133 and 134, and multipliers 135 and 136, which are functional blocks.

Current input to the current conversion unit 13 will be described. As described above, the current detection unit 12 detects the first three-phase alternating current detection values Iua, Iva, and Iwa and the second three-phase alternating current detection values Iub, Ivb, and Iwb in the period half the calculation period of the current control calculation carried out by the current control unit 14, and stores these detection values in the register of the microcomputer. The first three-phase alternating current detection values Iua, Iva, and Iwa represent currents that have been detected at the point of time preceding the start of the current control calculation task by the half of the current control calculation period. The second three-phase alternating current detection values Iub, Ivb, and Iwb represent currents that have been detected at the start of the current control calculation task. In each control period, the first three-phase alternating current detection values Iua, Iva, and Iwa and the second three-phase alternating current detection values Iub, Ivb, and Iwb, which are stored in the register of the microcomputer, are inputted simultaneously to the current conversion unit 13. Because the current control calculation is carried out once per control calculation period, the current conversion unit 13 averages currents obtained by two times of current detection in one control calculation period and outputs averaged currents as two pieces of sampling data, to the current control unit 14. One method of averaging currents is to carry out dq conversion of the first three-phase alternating current detection values Iua, Iva, and Iwa and of the second three-phase alternating current detection values Iub, Ivb, and Iwb to average currents on the dq-axes.

The first current conversion unit 131 carries out dq conversion of the first three-phase alternating current detection values Iua, Iva, and Iwa inputted by the current detection unit 12, based on the rotational position θ and the rotating speed ω. The first three-phase alternating current detection values Iua, Iva, and Iwa represent the currents that have been detected at the point of time preceding the start of the current control calculation by the half of the current control calculation period, and the rotational position θ and the rotating speed ω are the rotational position and the rotating speed that have been detected at the start of the current control calculation. This means that the point of time at which the currents have been detected is different from the point of time at which the rotational position θ has been detected. This makes it necessary that a rotation angle having advanced in a period between the point of time of current detection and the point of time of rotational position detection be calculated to estimate a rotation angle at the point of time of current detection and the dq conversion be carried out accordingly. A phase θₐ used for the dq conversion is given by equation (1).

θₐ=θ+(Ts[n−1]/2)×ω (1)

In equation (1), Ts[n−1] denotes a control period at the previous interruption. If the rotation speed, i.e., angular velocity ω is slow to change and does not change during the control period, the rotation angle at the point of time of current detection can be calculated by equation (1). Thus, a dq conversion result obtained is outputted as a first d-axis current value Id1 and a first q-axis current value Iq1.

The second current conversion unit 132 carries out dq conversion of the second three-phase alternating current detection values Iub, Ivb, and Iwb inputted by the current detection unit 12, based on the rotational position θ and the rotating speed ω. A dq conversion result obtained is thus outputted as a second d-axis current value Id2 and a second q-axis current value Iq2. Because the second three-phase alternating current detection values Iub, Ivb, and Iwb and the rotational position θ are detected at the same point of time, correcting the phase for the dq conversion, which is necessary in the case of the first current conversion unit, is unnecessary.

The adder 133 adds up the first d-axis current value Id1 outputted from the first current conversion unit 131 and the second d-axis current value Id2 outputted from the second current conversion unit 132. The multiplier 135 multiplies the sum of the first and second d-axis current values Id1 and Id2 by 0.5 and outputs the resulting value as the d-axis current value Id. In this manner, the d-axis current value Id is obtained as an average value of the first d-axis current value Id1 and the second d-axis current value Id2.

The adder 134 adds up the first q-axis current value Iq1 outputted from the first current conversion unit 131 and the second q-axis current value Iq2 outputted from the second current conversion unit 132. The multiplier 136 multiplies the sum of the first and second q-axis current values Iq1 and Iq2 by 0.5 and outputs the resulting value as the q-axis current value Iq. In this manner, the q-axis current value Iq is obtained as an average value of the first q-axis current value Iq1 and the second q-axis current value Iq2.

As described above, the current conversion unit 13 carries out the dq conversion of the first three-phase alternating current detection values Iua, Iva, and Iwa and the second three-phase alternating current detection values Iub, Ivb, and Iwb to be able to obtain the d-axis current value Id and the q-axis current value Iq. By this method, the current detection period can be doubled without changing the current control calculation period.

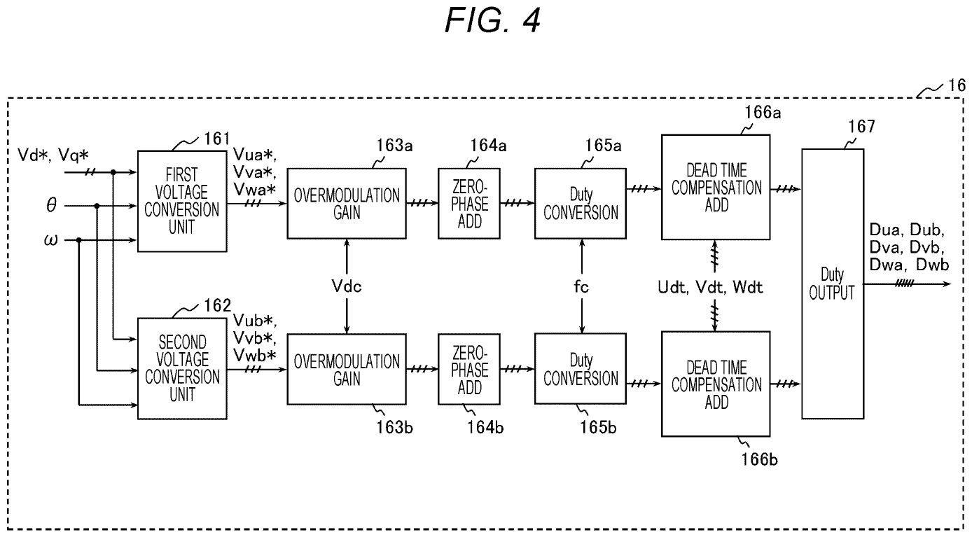

Details of the voltage control unit 16 in the motor control device 1 will then be described. FIG. 4 is a block diagram of the voltage control unit 16 according to the one embodiment of the present invention. The voltage control unit 16 includes a first voltage conversion unit 161, a second voltage conversion unit 162, overmodulation gain multipliers 163a and 163b, zero-phase adders 164a and 164b, duty conversion units 165a and 165b, dead time compensation adders 166a and 166b, and a duty output unit 167, which are functional blocks.

The first voltage conversion unit 161 carries out three-phase conversion of the d-axis voltage instruction Vd* and the q-axis voltage instruction Vq* that are inputted by the current control unit 14, based on the rotational position θ and the rotating speed ω, to obtain three-phase voltage instruction values used for a PWM calculation. In this process, the first voltage conversion unit 161 obtains, as three-phase voltage instruction values for the first half of the next control period, three-phase voltage instruction values corresponding to the rotational position θ at a point of time delayed by 1.25 control periods from a point of time of acquisition of the rotational position e and the first three-phase alternating current detection values Iua, Iva, and Iwa. A three-phase conversion result obtained is then outputted as first three-phase voltage instruction values Vua*, Vva*, and Vwa* (a first U-phase voltage instruction value Vua*, a first V-phase voltage instruction value Vva*, and a first W-phase voltage instruction value Vwa*) corresponding to the first half of the carrier wave.

The second voltage conversion unit 162 carries out three-phase conversion of the d-axis voltage instruction Vd* and the q-axis voltage instruction Vq* that are inputted by the current control unit 14, based on the rotational position θ and the rotating speed ω, to obtain three-phase voltage instruction values used for the PWM calculation. In this process, the second voltage conversion unit 162 obtains, as three-phase voltage instruction values for the latter half of the next control period, three-phase voltage instruction values corresponding to the rotational position θ at a point of time delayed by 1.75 control periods from the point of time of acquisition of the rotational position θ and the first three-phase alternating current detection values Iua, Iva, and Iwa. A three-phase conversion result obtained is then outputted as second three-phase voltage instruction values Vub*, Vvb*, and Vwb* (a second U-phase voltage instruction value Vub*, a second V-phase voltage instruction value Vvb*, and a second W-phase voltage instruction value Vwb*) corresponding to the second half of the carrier wave.

Based on the voltage Vdc of the high-voltage battery 5, the overmodulation gain multipliers 163a and 163b multiply the first three-phase voltage instruction values Vua*, Vva*, and Vwa* outputted from the first voltage conversion unit 161 and the second three-phase voltage instruction values Vub*, Vvb*, and Vwb* outputted from the second voltage conversion unit 162, respectively, by a given overmodulation gain. The overmodulation gain is a gain used for overmodulation control by which an output voltage from the inverter 3 is raised to have an amplitude larger than the amplitude of a fundamental wave component. The overmodulation gain is set to, for example, a value equal to or larger than 1. When the overmodulation control is not performed, the overmodulation gain may be set to 1.

The zero-phase adders 164a and 164b add a given zero-phase voltage value respectively to the first three-phase voltage instruction values Vua*, Vva*, and Vwa* and the second three-phase voltage instruction values Vub*, Vvb*, and Vwb*, which have been multiplied by the overmodulation gain by the overmodulation gain multipliers 163a and 163b, respectively. Adding the zero-phase voltage value is a process of improving an AC voltage output for the voltage Vdc of the high-voltage battery 5 (a process of improving a voltage use rate). The zero-phase voltage value is determined according to, for example, a combination of the first three-phase voltage instruction values Vua*, Vva*, and Vwa* or of the second three-phase voltage instruction values Vub*, Vvb*, and Vwb*, the rotational position θ, and the like. Adding the zero-phase voltage value is not always required, and therefore the voltage control unit 16 may dispense with the zero-phase adders 164a and 164b.

The duty conversion units 165a and 165b perform a PWM calculation respectively on the first three-phase voltage instruction values Vua*, Vva*, and Vwa* and the second three-phase voltage instruction values Vub*, Vvb*, and Vwb* to which the zero-phase voltage value have been added by the zero-phase adders 164a and 164b, the PWM calculation using the carrier wave periodically changing at the carrier frequency fc, thereby converting these three-phase voltage instruction values into duty values of three phases, i.e., the U phase, the V phase, and the W phase. It should be noted that, as described above, the first three-phase voltage instruction values Vua*, Vva*, and Vwa* are generated as voltage instruction values corresponding to the first half of the carrier wave, and the second three-phase voltage instruction values Vub*, Vvb*, and Vwb* are generated as voltage instruction values corresponding to the second half of the carrier wave. Therefore, the duty conversion unit 165a obtains duty values of three phases corresponding to the first half of the carrier wave, based on the first three-phase voltage instruction values Vua*, Vva*, and Vwa*. The duty conversion unit 165b, on the other hand, obtains duty values of three phases corresponding to the second half of the carrier wave, based on the second three-phase voltage instruction values Vub*, Vvb*, and Vwb*.

The dead time compensation adders 166a and 166b carry out dead time compensation of the duty values of three phases obtained respectively by the duty conversion units 165a and 165b, by adding given dead time compensation values Udt, Vdt, and Wdt of three phases, respectively, to the duty values of three phases. A dead time compensation value is a value that is added, when necessary, to a duty value of each phase to prevent the switching elements of the upper and lower arms of each phase from switching on simultaneously. Details of dead time compensation by the dead time compensation adders 166a and 166b will be described later.

The duty output unit 167 outputs the duty instruction values Dua, Dub, Dva, Dvb, Dwa, and Dwb, based on the duty values of three phases having been subjected to the dead time compensation by the dead time compensation adders 166a and 166b. In this process, the duty output unit 167 outputs the duty values Dua, Dva, and Dwa in their states after dead time compensation that correspond to the first half of the carrier wave, the duty values Dua, Dva, and Dwa being outputted from the dead time compensation adder 166a, based on the first three-phase voltage instruction values Vua*, Vva*, and Vwa*, and outputs the duty values Dub, Dvb, and Dwb in their states after dead time compensation that correspond to the second half of the carrier wave, the duty values Dub, Dvb, and Dwb being outputted from the dead time compensation adder 166b, based on the second three-phase voltage instruction values Vub*, Vvb*, and Vwb*.

As described above, from the d-axis voltage instruction Vd* and the q-axis voltage instruction Vq*, the voltage control unit 16 can obtain the duty instruction values Dua, Dub, Dva, Dvb, Dwa, and Dwb of which (Dua, Dva, Dwa) and (Dub, Dvb, Dwb) correspond respectively to the first half and the second half of the carrier wave in three phases.

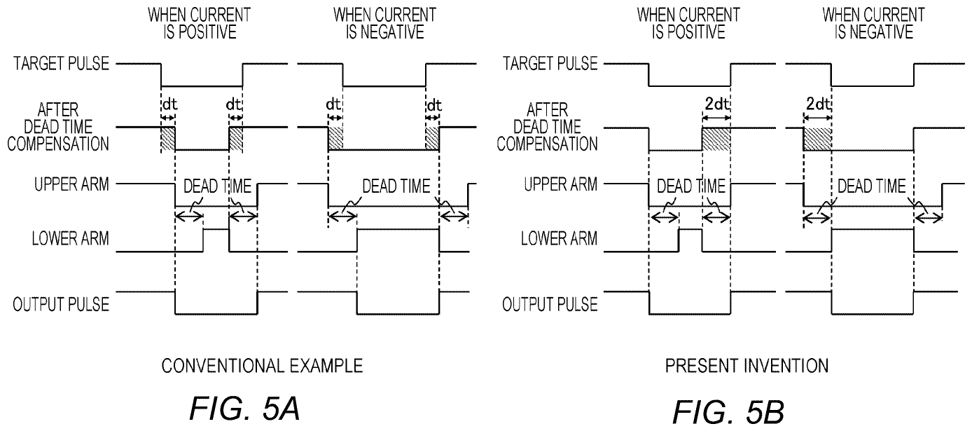

Details of dead time compensation by the dead time compensation adders 166a and 166b will then be described with reference to FIGS. 5A to 5B. FIGS. 5A to 5B are a comparison chart in which dead time compensation according to a conventional example and dead time compensation according to the present invention are compared with each other.

FIG. 5A shows the state of dead time compensation according to a conventional example to which the present invention is not applied. A case is assumed where when a current flowing in the motor 2 is positive, for example, a target pulse shown on a left part of FIG. 5A is inputted as a duty value in its state before execution of dead time compensation of one of three phases. In this case, adding a given compensation duty dt equivalent to a dead time compensation value, to the head and the tail of the target pulse shifts respective positions of a falling edge and a rising edge of the target pulse, thus creating a pulse waveform in its state after dead time compensation, as shown in FIG. 5A. Based on the pulse waveform in its state after dead time compensation that is generated in the above manner, pulse waveforms of the upper arm and the lower arm are generated, with a dead time set for a mutual timing difference. Hence an output pulse corresponding to the original target pulse is generated.

Another case is assumed where when a current flowing in the motor 2 is negative, for example, a target pulse shown on a right part of FIG. 5A is inputted as a duty value in its state before execution of dead time compensation of one of three phases. In this case, subtracting the given compensation duty dt equivalent to the dead time compensation value, from the head and the tail of the target pulse shifts respective positions of a falling edge and a rising edge of the target pulse, thus creating a pulse waveform in its state after dead time compensation, as shown in FIG. 5A. Based on the pulse waveform in its state after dead time compensation that is generated in the above manner, pulse waveforms of the upper arm and the lower arm are generated, with a dead time set for a mutual timing difference. Hence an output pulse corresponding to the original target pulse is generated.

It is understood, by comparison with the original target pulse in its state before dead time compensation, that in both cases of the current being positive and being negative, the output pulse of the conventional example that is generated in the above manner develops a delay equivalent to the compensation duty dt.

FIG. 5B shows the state of dead time compensation according to the embodiment to which the present invention is applied. A case is assumed where when a current flowing in the motor 2 is positive, for example, a target pulse shown on a left part of FIG. 5B is inputted to the dead time compensation adders 166a and 166b, as a duty value in its state before execution of dead time compensation of one of three phases. In this case, the dead time compensation adder 166a does not carry out dead time compensation as the dead time compensation adder 166b adds a value two times the compensation duty dt to the target pulse. This shifts the position of a rising edge of the target pulse, thus creating a pulse waveform in its state after dead time compensation, as shown in FIG. 5B. Based on the pulse waveform in its state after dead time compensation that is generated in the above manner, pulse waveforms of the upper arm and the lower arm are generated, with a dead time set for a mutual timing difference. Hence an output pulse corresponding to the original target pulse is generated.

Another case is assumed where when a current flowing in the motor 2 is negative, for example, a target pulse shown on a right part of FIG. 5B is inputted to the dead time compensation adders 166a and 166b, as a duty value in its state before execution of dead time compensation of one of three phases. In this case, the dead time compensation adder 166b does not carry out dead time compensation as the dead time compensation adder 166a subtracts a value two times the compensation duty dt from the target pulse. This shifts the position of a falling edge of the target pulse, thus creating a pulse waveform in its state after dead time compensation, as shown in FIG. 5B. Based on the pulse waveform in its state after dead time compensation that is generated in the above manner, pulse waveforms of the upper arm and the lower arm are generated, with a dead time set for a mutual timing difference. Hence an output pulse corresponding to the original target pulse is generated.

It is understood, by comparison with the original target pulse in its state before dead time compensation, that in both cases of the current being positive and being negative, the output pulse of the present invention that is generated in the above manner does not develop a delay, which is developed in the conventional example.

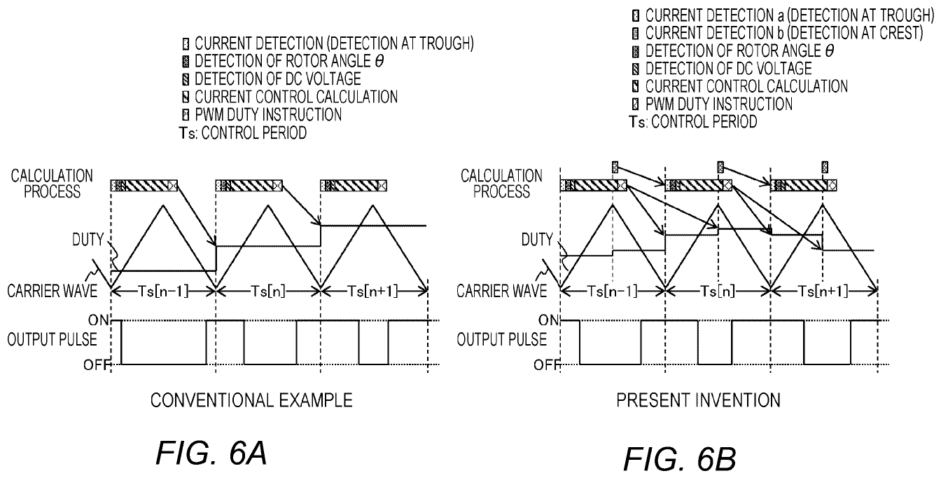

FIGS. 6A to 6B are a comparison chart in which a calculation process according to the conventional example and a calculation process according to the present invention are compared with each other.

FIG. 6A shows the state of the calculation process according to the conventional example to which the present invention is not applied. In the conventional example, a series of calculation processes including current detection and PWM duty instruction output are repeatedly carried out in respective periods of the triangular carrier wave changing periodically at the carrier frequency fc, so that a gate signal, which is an output pulse corresponding to the torque instruction T*, is outputted from the motor control device 1 to the inverter 3.

In the calculation process of the conventional example shown in FIG. 6A, current detection is carried out only once in each control period. In addition, a result of a calculation process carried out in each control period is reflected only once in a duty of the next control period, at a trough of the carrier wave. For example, in a control period Ts[n], current detection is carried out first at a trough of the carrier wave and then a calculation process is executed based on a result of the current detection. A duty instruction value obtained by the calculation process in the control period Ts[n] is outputted at a trough of the carrier wave, as a gate signal for adjusting an output voltage from the inverter 3 in the next control period Ts[n+1].

FIG. 6B shows the state of the calculation process according to the embodiment to which the present invention is applied. In this embodiment, current detection is carried out twice in each control period of the triangular carrier wave changing periodically at the carrier frequency fc. Then, using results of two rounds of current detection carried out just before, a series of calculation processes are carried out repeatedly in the same manner as in the conventional example, so that a gate signal, which is an output pulse corresponding to the torque instruction T*, is outputted from the motor control device 1 to the inverter 3.

In the calculation process of this embodiment shown in FIG. 6B, current detection is carried out twice in each control period. In addition, a result of a calculation process carried out in each control period is reflected in a duty of the next control period, at a trough of the carrier wave and at a crest of the same as well. For example, in each of control periods Ts[n−1] and Ts[n], current detection is carried out at a trough of the carrier wave and at a crest of the same as well. A calculation process in the control period Ts[n] is carried out based on a current value detected at a crest of the carrier wave in the control period Ts[n−1] right before the control period Ts[n] and on a current value detected at a trough of the carrier wave at the start of the control period Ts[n]. A duty instruction value obtained by the calculation process in the control period Ts[n] is outputted as a gate signal for adjusting an output voltage from the inverter 3 in the next control period Ts[n+1], at a trough of the carrier wave and at a crest of the same as well.

In the motor control device 1 of this embodiment, the motor 2 is controlled via the inverter 3 through the calculation process as described above. As a result, in each calculation period, a current detection value is acquired twice and two kinds of duty instructions are obtained, and these current detection values and duty instructions can be reflected in control of the motor 2. Thus, control of the motor 2 that reflects results of detection of a current flowing through the motor 2 more meticulously than in the conventional example is achieved without increasing the number of current control calculations per carrier wave, and therefore motor control performance can be improved.

This embodiment has been described as the example in which a current detection value is acquired twice in each calculation period and two kinds of duty instructions are obtained in each calculation period, based on the acquired current detection values. However, the present invention is not limited to this example, and the number of times of acquisition of the current detection value in each calculation period and the number of kinds of duty instructions obtained in each calculation period may each be determined to be 3 or more. The present invention can be applied to any example in which the current detection value is acquired at least twice in each calculation period and at least two kinds of duty instructions are obtained in each calculation period.

The above-described one embodiment of the present invention offers the following advantageous effects.
(1) The motor control device 1 generates a gate signal for controlling operation of a switching element of the inverter 3 having a plurality of the switching elements, and outputs the generated gate signal to the inverter 3, thereby controlling driving of the AC motor 2 connected to the inverter 3. The motor control device 1 includes: the current detection unit 12 that acquires a current detection value corresponding to a current flowing through the AC motor 2; the current control unit 14 that acquires a current instruction value to the AC motor 2 and that calculates a voltage instruction value to the AC motor 2 in each calculation period that is a given calculation period, based on the current instruction value and on the current detection value; and the voltage control unit 16 that executes a control calculation based on the voltage instruction value in the each calculation period to obtain a duty instruction for generating the gate signal. The current detection unit 12 acquires the current detection value at least twice in each calculation period, and the voltage control unit 16 obtains at least two kinds of the duty instructions in each calculation period and reflects the duty instructions in the gate signal. Because of this configuration, in motor control at the time of high-speed rotation of the motor, motor control performance can be improved as an increase in a processing load is suppressed.
(2) The motor control device 1 includes the current conversion unit 13 that converts detection values of three-phase alternating currents acquired by the current detection unit 12 into the d-axis current value Id and the q-axis current value Iq. The current detection unit 12 acquires the first three-phase alternating current detection values Iua, Iva, and Iwa and the second three-phase alternating current detection values Iub, Ivb, and Iwb at different timings in the calculation period. The current conversion unit 13 calculates the first d-axis current value Id1 and first q-axis current value Iq1 based on the first three-phase alternating current detection values Iua, Iva, and Iwa, and the second d-axis current value Id2 and second q-axis current value Iq2 based on the second three-phase alternating current detection values lub, Ivb, and Iwb, using the first current conversion unit 131 and the second current conversion unit 132, respectively. The current conversion unit 13 then obtains the d-axis current value Id from an average value of the first d-axis current value Idl and the second d-axis current value Id2 and obtains the q-axis current value Iq from an average value of the first q-axis current value Iq1 and the second q-axis current value Iq2 as well, using the adders 133 and 134 and the multipliers 135 and 136, respectively. The current control unit 14 calculates the d-axis voltage instruction Vd* and the q-axis voltage instruction Vq*, which are voltage instruction values to the AC motor 2, based on the d-axis current instruction Id* and the q-axis current instruction Iq* to the AC motor 2 and on the d-axis current value Id and the q-axis current value Iq obtained by the current conversion unit 13. Because of this configuration, the current control unit 14 can properly calculate a voltage instruction value to the AC motor 2, using a current detection value the current detection unit 12 acquires twice in each calculation period.
(3) The current control unit 14 calculates the d-axis voltage instruction Vd* and the q-axis voltage instruction Vq* in each calculation period that is a given calculation period. Based on the d-axis voltage instruction Vd* and the q-axis voltage instruction Vq*, the voltage control unit 16 calculates the first three-phase voltage instruction values Vua*, Vva*, and Vwa* at a first timing in the calculation period and the second three-phase voltage instruction values Vub*, Vvb*, and Vwb* at a second timing different from the first timing in the calculation period, using the first voltage conversion unit 161 and the second voltage conversion unit 162, respectively. The voltage control unit 16

calculates also first duty values based on the first three-phase voltage instruction values Vua*, Vva*, and Vwa* and second duty values based on the second three-phase voltage instruction values Vub*, Vvb*, and Vwb*, using the overmodulation gain multipliers 163a and 163b, the zero-phase adders 164a and 164b, the duty conversion units 165a and 165b, and the dead time compensation adders 166a and 166b. Then, the duty output unit 167 obtains the duty instruction values Dua, Dub, Dva, Dvb, Dwa, and Dwb, based on these duty values. Because of this configuration, the voltage control unit 16 is able to certainly obtain two kinds of duty instructions in each calculation period and to reflect these duty instructions in the gate signal.
(4) The voltage control unit 16 carries out dead time compensation by adding a given dead time compensation value to the first three-phase voltage instruction values Vua*, Vva*, and Vwa* and to each of the second three-phase voltage instruction values Vub*, Vvb*, and Vwb*, using the dead time compensation adders 166a and 166b, respectively, and obtains the first duty value and the second duty value, based on the first three-phase voltage instruction values Vua*, Vva*, and Vwa* and the second three-phase voltage instruction values Vub*, Vvb*, and Vwb* in their states after dead time compensation, respectively. Because of this configuration, dead time compensation of the duty instruction values Dua, Dub, Dva, Dvb, Dwa, and Dwb can be carried out certainly to prevent the upper arm and the lower arm of each phase from switching on simultaneously in the inverter 3.

It should be noted that the present invention is not limited to the above-described embodiment and that the present invention can be modified in various forms within a range that does not depart from the substance of the present invention.

### REFERENCE SIGNS LIST

1 motor control device
2 motor
3 inverter
4 rotational position detector
5 high-voltage battery
7 current sensor
8 rotational position sensor
10 current instruction generation unit
11 speed calculation unit
12 current detection unit
13 current conversion unit
14 current control unit
15 carrier frequency control unit
16 voltage control unit
17 gate signal generation unit
31 inverter circuit
32 gate drive circuit
33 smoothing capacitor
100 motor drive system

1. A motor control device that generates a gate signal for controlling operation of a switching element of an inverter having a plurality of the switching elements and outputs the generated gate signal to the inverter, thereby controlling driving of an AC motor connected to the inverter, the motor control device comprising:
a current detection unit that acquires a current detection value corresponding to a current flowing through the AC motor;
a current control unit that acquires a current instruction value to the AC motor and that calculates a voltage instruction value to the AC motor in each calculation period that is a given calculation period, based on the current instruction value and on the current detection value; and
a voltage control unit that executes a control calculation based on the voltage instruction value in the each calculation period to obtain a duty instruction for generating the gate signal, wherein
the current detection unit acquires the current detection value at least twice in the each calculation period, and
the voltage control unit obtains at least two kinds of the duty instructions in the each calculation period and reflects the duty instructions in the gate signal.

2. The motor control device according to claim 1, comprising
a current conversion unit that converts the current detection value into a d-axis current value and a q-axis current value, wherein
the current detection unit acquires a first current detection value and a second current detection value at different timings in the calculation period,
the current conversion unit
calculates a first d-axis current value and a first q-axis current value, based on the first current detection value, and calculates also a second d-axis current value and a second q-axis current value, based on the second current detection value,
obtains the d-axis current value from an average value of the first d-axis current value and the second d-axis current value and
obtains the q-axis current value from an average value of the first q-axis current value and the second q-axis current value, and
the current control unit calculates the voltage instruction value, based on a d-axis current instruction value and a q-axis current instruction value to the AC motor and on the d-axis current value and the q-axis current value that have been obtained by the current conversion unit.

3. The motor control device according to claim 1, wherein
the current control unit calculates a d-axis voltage instruction value and a q-axis voltage instruction value in the each calculation period, and
the voltage control unit
calculates a first three-phase voltage instruction value at a first timing in the calculation period and a second three-phase voltage instruction value at a second timing different from the first timing in the calculation period, based on the d-axis voltage instruction value and on the q-axis voltage instruction value,
calculates a first duty value based on the first three-phase voltage instruction value and a second duty value based on the second three-phase voltage instruction value, and
obtains the duty instruction, based on the first duty value and on the second duty value.

4. The motor control device according to claim 3, wherein
the voltage control unit carries out dead time compensation by adding a given dead time compensation value to each of the first three-phase voltage instruction value and the second three-phase voltage instruction value, and obtains the first duty value and the second duty value, based on the first three-phase voltage instruction value and the second three-phase voltage instruction value in their states after the dead time compensation.
